(19) United States
(12) Patent Application Publication
(10) Pub. No.: US 2003/0194522 A1
(43) Pub. Date: Oct. 16, 2003

(54) Aqueous liquid contact rubber part

(76) Inventors: Hidekazu Kurimoto, Aichi-ken (JP); Kiyomitsu Terashima, Aichi-ken (JP)

Correspondence Address: POSZ & BETHARDS, PLC, 11250 ROGER BACON DRIVE, SUITE 10, RESTON, VA, 20190, US

(21) Appl. No.: 10/409,069

(22) Filed: Apr. 9, 2003

(30) Foreign Application Priority Data
Apr. 12, 2002 (JP) 2002-111031
Jan. 31, 2003 (JP) 2003-024888

(51) Int. Cl. B32B 1/08

(52) U.S. Cl. 428/36.91

(57) ABSTRACT

An object of the present invention is to provide a coolant transporting hose, which requires no cleaning treatment and also cause no problems in the coolant transporting hose itself and a fuel cell system, and a rubber material capable of forming the coolant transporting hose.

Disclosed is An aqueous liquid contact rubber part having a contact portion with an aqueous liquid. The contact portion with the rubber part is made of at least a rubber vulcanizate having a volume resistivity of 10¹⁰ Ω.cm or more. When the rubber vulcanizate is immersed in an aqueous liquid having a specific conductivity (25° C.) of 3 μS/cm or less in an amount of 10 times as much the rubber vulcanizate at 100° C. for 168 hours, the specific conductivity (25° C.) of the aqueous liquid does not exceed 50 μS/cm.

### BACKGROUND OF THE INVENTION

1. Field of the Invention

The present invention relates to an aqueous liquid contact rubber part having a contact portion with an aqueous liquid. While the aqueous liquid contact rubber part will be described by way of a coolant transporting hose for a fuel cell powered electric vehicle in the present specification, the aqueous liquid contact rubber part of the present invention can also be applied to other aqueous liquid contact rubber part such as diaphragm and packing.

2. Description of the Related Art

A coolant transporting hose used as automotive parts has a structure in which a coolant as an aqueous liquid flows through the inside thereof and, therefore, the contact portion (inner layer) with the coolant is made of at least a material having high water resistance. At present, a rubber vulcanizate obtained by vulcanizing a rubber composition composed mainly of an ethylene-α olefin copolymer such as EPDM is widely used.

The rubber vulcanizate usually contains a large amount of carbon black such as a reinforcing filler, and the carbon black causes a problem that the conductivity of the material increases because the carbon black is a conductive filler. In case a coolant transporting hose having high conductivity is assembled into a vehicle using various members for an electric system, a stray current (electric leakage) occurs because the coolant transporting hose easily carries electric current. It is known that this stray current causes the electrochemical reaction between the hose and a compound in the coolant, thereby to deteriorate the hose itself.

To prevent the occurrence of the stray current, the prior art proposes a coolant transporting hose made of low-conductivity rubber vulcanizate having of a volume resistivity of 10⁴ Ω.cm or more. It is considered that, when the volume resistivity of 10⁴ Ω.cm or more, the coolant transporting hose is not electrically deteriorated because of excellent resistance to electrical deterioration.

For example, Patent Document 1 describes a coolant transporting hose made of a vulcanized rubber (volume resistivity: 10⁴ Ω.cm or more) containing 30 to 35% by weight of carbon black having an iodine absorption amount of 10 to 30 mg/g and a DBP oil absorption amount of 110 cm³/100 g or more.

Also Patent Document 2 describes a coolant transporting hose made of a ZnO-free peroxide vulcanized rubber (volume resistivity: 10⁴ Ω.cm or more) containing 36 to 41% by weight of carbon black having an iodine absorption amount of 10 to 30 mg/g and a DBP oil absorption amount of 110 cm³/100 g or more.

Patent Documents 3 to 7 exist as a related art of the aqueous liquid transporting hose of the present invention, though they exert no influence on the inventiveness of the present invention.

[Patent Document 1]

Japanese Unexamined Patent Publication (Kokai) No. Hei 9-317956

[Patent Document 2]

Japanese Unexamined Patent Publication (Kokai) No. Hei 10-19173

[Patent Document 3]

Japanese Unexamined Patent Publication (Kokai) No. Hei 3-194281

[Patent Document 4]

Japanese Unexamined Patent Publication (Kokai) No. Hei 6-262729

[Patent Document 5]

Japanese Unexamined Patent Publication (Kokai) No. Hei 11-315967

[Patent Document 6]

Japanese Unexamined Patent Publication (Kokai) No. Hei 11-12408

[Patent Document 7]

Japanese Unexamined Patent Publication (Kokai) No. 2001-106848

However, a fuel cell powered electric vehicle, which has recently attracted special interest and developed, carries electric current more easily as compared with a conventional gasoline powered vehicle and thus a stray current (electric leakage) is likely to occur. Therefore, when a conventional coolant transporting hose (hose having a volume resistivity of 10⁴ Ω.cm or more) is applied to the fuel cell powered electric vehicle, the hose and a compound in the coolant causes the electrochemical reaction, thereby to cause cracking in the hose itself.

It is known that, in the conventional coolant transporting hose, since an electrolyte component (for example, ions) included in the rubber vulcanizate constituting the hose is gradually dissolved in the coolant, the conductivity of the coolant gradually increases. Therefore, the coolant easily carries electric current and thus electrical deterioration of the inside of the hose is promoted and there arises problems in control of fuel cell system.

Consequently, when the conductivity of the coolant increases to some extent, the coolant must be replaced by a coolant having low conductivity. To suppress an increase in conductivity of the coolant, an ion-exchange filter must be provided, resulting in poor economy.

To solve the problems described above, the present applicant proposed, in Japanese Patent Application No. 2001-371945 (not laid-open on the priority date), a channel component (coolant transporting hose etc.) with the following constitution:

“A channel component for a fluid, the fluid flowing through an internal space of the channel component, characterized in that the channel component is subjected to a cleaning treatment of contacting a solvent capable of dissolving an electrolyte component included in the wall thickness portion of the channel component with at least the inner surface of the channel component for a predetermined time, thereby to reduce the electrolyte component included in the wall thickness portion”.

With the above constitution, it is made possible to decrease dissolution of the electrolyte component (for example, ions) included in the rubber vulcanizate constituting the coolant transporting hose into the coolant.

However, the coolant transporting hose was troublesome because a cleaning step is required in the manufacture of the coolant transporting hose and lots of man-hours are spent.

### SUMMARY OF THE INVENTION

Under these circumstances, the present invention has been made and an object of the present invention to provide a rubber part for an aqueous liquid, which have far higher resistance to electric current and are capable of suppressing an increase in conductivity of an aqueous liquid to be contacted even if the rubber part is not subjected to a cleaning treatment.

To achieve the above object, the present inventors have intensively studied and achieved an aqueous liquid contact rubber part with the following constitution.

The present invention is directed to an aqueous liquid contact rubber part having a contact portion with an aqueous liquid, wherein a contact portion with the aqueous parts is made of a rubber vulcanizate having a volume resistivity of 10¹⁰ Ω.cm or more, and

when the rubber vulcanizate is immersed in an aqueous liquid having a specific conductivity (25° C.) of 3 μS/cm or less in an amount of 10 times as much the rubber vulcanizate at 100° C. for 168 hours, the specific conductivity (25° C.) of the aqueous liquid does not exceed 50 μS/cm.

When an aqueous liquid contact rubber part is made of a rubber vulcanizate having a volume resistivity of 10¹⁰ Ω.cm or more, the resulting aqueous liquid contact rubber part has far higher resistance to electric current as compared with the prior art. Even if the aqueous liquid is contacted with the aqueous liquid contact rubber part, the specific conductivity of the aqueous liquid can be maintained at a low value, and thus deterioration of the aqueous liquid contact rubber part can be prevented and also the occurrence of problems of the system can be prevented.

Expressing through the formulation (constitution) of a rubber composition that forms a rubber vulcanizate wherein the specific conductivity of the aqueous liquid does not exceed a predetermined value when the aqueous liquid contact rubber part is immersed in the aqueous liquid, it is as follows:

The present invention is also directed to an aqueous liquid contact rubber part having a contact portion with an aqueous liquid, wherein:

a the contact portion with the aqueous parts is made of a rubber vulcanizate having a volume resistivity of 10¹⁰ Ω.cm or more,

the rubber vulcanizate is made of a peroxide vulcanized rubber composition containing an ethylene-α olefin copolymer as a raw rubber and carbon black as a reinforcing filler,

the carbon black has characteristic values of an iodine absorption amount of about 10 to 30 mg/g and a DBP oil absorption amount of about 110 to 140 cm³/100 g, and

the amount of the carbon black is from about 18 to 32% (preferably about 18 to 29% by weight) by weight.

With the above constitution, it becomes easy to suppress an increase in specific conductivity when immersed in the aqueous liquid. That is, it becomes more secure to obtain an aqueous liquid contact rubber part, which have far higher resistance to electric current as compared with a conventional product and cause less dissolution of the electrolyte component into the liquid to be contacted when applied to the coolant transporting hose.

It is preferred that the reinforcing filler of the rubber composition contains a white filler together with the carbon black and the amount of the white filler is about 22% by weight or less. By mixing the white filler, the extrusion processability is improved and it becomes easy to decrease the volume resistivity of the rubber vulcanizate by relatively reducing the amount of carbon black. When the amount of the white filler is too large, it becomes difficult to impart the desired reinforcing effect to the rubber vulcanizate.

In the above constitution, the white filler is preferably a combination of a surface-treated clay and a surface-treated calcium carbonate. The surface-treated clay improves the extrusion processability and the surface-treated calcium carbonate and the surface-treated clay can complement a decrease in strength such as tensile strength caused by reducing the amount of the carbon black.

In the above constitution, the rubber composition is substantially free from ZnO, preferably. When the rubber composition does not contain ZnO, it is made possible to reduce the amount of the electrolyte component dissolved from the rubber vulcanizate into the liquid to be contacted.

In the above constitution, the rubber part is used as a coolant transporting hose for a fuel cell powered electric vehicle and the coolant is an ethylene glycol-containing aqueous liquid, the effect of the present invention becomes more remarkable. That is, it is made possible to prevent the occurrence of electric leakage (stray current) in the vehicle and also deterioration of the coolant transporting hose caused by the increase in specific conductivity of the aqueous liquid and the occurrence of problems of the fuel cell system can be suppressed as compared with the prior art.

### BRIEF DESCRIPTION OF THE DRAWING

FIG. 1 is a partial sectional view showing a coolant transporting hose for a fuel cell powered electric vehicle according to an embodiment of an aqueous liquid contact rubber part of the present invention.

FIG. 2 is a graph showing a relation between the carbon black content and the volume resistivity.

### DETAILED DESCRIPTION OF THE PREFERRED EMBODIMENTS

The aqueous liquid contact rubber part of the present invention and the rubber composition used to manufacture the aqueous liquid contact rubber part will now be described in detail. In the present specification, percentages are by weight unless otherwise specified.

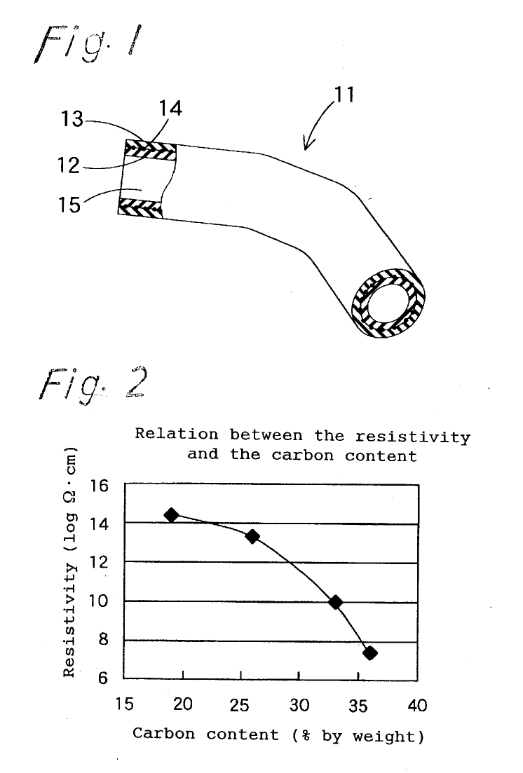

FIG. 1 is a partial sectional view showing a coolant transporting hose 11 for a fuel cell powered electric vehicle according to an embodiment of the aqueous liquid contact rubber part of the present invention.

The coolant transporting hose 11 in FIG. 1 comprises an inner tube layer 12 as a contact portion with a coolant (aqueous liquid) and an outer tube layer 13 formed directly on the periphery of the inner tube layer 12. Between the inner tube layer 12 and the outer tube layer 13, a reinforcing layer 14 is usually formed.

The coolant transporting hose 11 is used as a hose for connecting a fuel cell to a radiator in a fuel cell powered electric vehicle, in which a coolant flows through an internal space 15 at the inside of the inner tube layer 12.

The coolant is an aqueous liquid containing water as a main component. Usually, an aqueous liquid having a specific conductivity (25° C.) of about 2 μS/cm, which is prepared by mixing water with a proper amount of a coolant (long life coolant=LLC) containing ethylene glycol and a rust inhibitor, is used. The specific conductivity of the coolant is controlled to prevent promotion of electrical deterioration of the inner surface of the hose and problems in control of the fuel cell system as a result of carry of electric current of the coolant. For reference, the specific conductivity (25° C.) of tap water is within a range from 70 to 90 μS/cm, while the specific conductivity of deionized water is about 1 μS/cm or less. It is, therefore, necessary to use tap water after deionization.

The inner tube layer 12 and the outer tube layer 13 of the coolant transporting hose 11 are made of a rubber vulcanizate having a volume resistivity (JIS K 6911) of 10¹⁰ Ω.cm or more, preferably 10¹² Ω.cm or more, and more preferably 10¹³ Ω.cm or more. A coolant transporting hose, which has far higher resistance to electric current as compared with the prior art, can be obtained by forming the inner tube layer 12 and the outer tube layer 13 using a rubber vulcanizate having a volume resistivity of 10¹⁰ Ω.cm or more. Therefore, it is made possible to prevent the occurrence of electric leakage (stray current) in the vehicle.

When a test sample (in size of 20 mm×20 mm×2 mm thickness) of the rubber vulcanizate constituting the inner tube layer 12 is immersed in an aqueous liquid having a specific conductivity (25° C.) of 3 μS/cm or less in an amount of 10 times as much the rubber vulcanizate at 100° C. for 168 hours, the specific conductivity (25° C.) of the aqueous liquid does not exceed 50 μS/cm.

When the inner tube layer 12 is made of the rubber vulcanizate, the specific conductivity of the coolant can always be maintained at a low value (for example, 50 μS/cm or less) even if the coolant is contacted. Since the rubber vulcanizate is made of a peroxide vulcanized rubber composition and does not contain a sulfur vulcanization type vulcanization accelerator (electrolyte component), it causes less dissolution of the electrolyte component such as ions into the coolant due to the vulcanization accelerator. Therefore, it is made possible to prevent the occurrence of electric leakage (stray current) in the vehicle and deterioration of the hose itself can be prevented. Furthermore, the occurrence of problems of the system can be prevented as compared with the prior art.

Blade knitting or spiral knitting of a thread-like material around the periphery of the inner tube layer 12 forms the reinforcing layer 14. As the thread-like material, thread-like materials used in a conventional hose having a reinforcing layer, for example, polyamide resin, cellulose regenerated fibers, polyester fibers and aramid fibers. This reinforcing layer 14 suppresses expansion of the hose in a radial direction due to a pressure produced when the coolant flows through the inside of the inner tube layer 12.

The rubber vulcanizate constituting the inner tube layer 12 is obtained by vulcanizing a peroxide vulcanized rubber composition of a raw rubber which is composed or composed mainly of an ethylene-α olefin copolymer (EOR).

The raw rubber is composed or composed mainly of EOR because it substantially has an unsaturated bond on main chain and has good weatherability.

Since the peroxide vulcanized rubber composition can be vulcanized without using a vulcanization accelerator, it can remarkably reduce the amount of the electrolyte component dissolved into the coolant as compared with a rubber vulcanizate obtained by sulfur vulcanization, and therefore it is useful. The present inventors conducted a dissolution test of the electrolyte component using a sulfur vulcanized product containing a vulcanization accelerator and a peroxide vulcanized product containing no vulcanization accelerator and confirmed a remarkable difference.

As EOR, for example, EPM as a two-component copolymer of an ethylene component and a propylene component; and EPDM as a three-component copolymer containing a diene compound such as 1,4-hexadiene, dicyclopentadiene or ethylidene norbornene as a third component are widely used. There can also be used those obtained by copolymerizing ethylene with the other α-olefin such as 1-butene, 1-pentene or 1-hexene alone or in combination with propylene.

Examples of the other raw rubber (polymer component) used in combination with EOR in the raw rubber include a small amount of rubbers such as natural rubber (NR), styrene-butadiene copolymer (SBR), butadiene rubber (BR), butadiene-acrylonitrile copolymer (NBR), chloroprene rubber (CR), polysulfide rubber (T), hydrogenated nitrile rubber (H-NBR), epichlorohydrin rubber (CO, GCO, ECO, GECO) and fluororubber (FKM).

Examples of the vulcanizing agent (organic peroxide), which can be used in the peroxide vulcanization system, include general-purpose vulcanizing agents such as dicumyl peroxide (DCP), 2,4-dichlorobenzoyl peroxide, benzoyl peroxide, 2,5-dimethl 2,5-benzoyl peroxyhexane, n-butyl-4,4-di-t-butyl peroxyvalerate, t-butyl peroxybenzoate, di-t-butylperoxy-diidopropylbenzene, t-butyl cumylperoxide, 2,5-dimethyl 2,5-di-t-butylperoxyhexane, di-t-butyl peroxide and 2,5-dimethyl 2,5-di-t-butylperoxyhexyne-3.

As the auxiliary crosslinking agent, for example, sulfur, dipentamethylenethiuram tetrasulfide (DPTT), dibenzoylquinone oxime, triallyl isocyanurate, trimethylolpropane trimethacrylate and ethylene glycol dimethacrylate may be mixed. When sulfur is mixed, physical properties such as tensile strength and elongation can be improved.

As the reinforcing filler in the rubber composition, carbon black is used and is preferably used in combination with a white filler.

The white filler (whose conductivity is noticeably lower than that of carbon black) as the reinforcing filler other than carbon black is mixed by the following reasons. That is, the mixing proportion of the carbon black is relatively reduced, thereby to increase the volume resistivity of the rubber vulcanizate and also an orienting filler is mixed, thereby to secure kneadability and processability (especially extrusion processability) and strength such as tensile strength due to the decrease of the mixing proportion of the carbon black.

As the carbon black, carbon black having characteristic values of an iodine absorption amount of about 10 to 30 mg/g (preferably about 18 to 22 mg/g) and a DBP oil absorption amount of about 110 to 140 cm³/100 g (preferably about 120 to 130 cm³/100 g) is used. The iodine absorption amount and the DBP oil absorption amount are indexes, which show basic performances of carbon black for rubber, defined in JIS K 6217.

Like the carbon black, when the iodine absorption amount is too small, the particle diameter is large and the tensile strength of the rubber vulcanizate is low. On the other hand, when the DBP oil absorption amount is too large, the particle diameter is small and thus the resulting rubber composition is likely to be inferior in kneadability and extrusion processability.

When the DBP oil absorption amount is too small, the tensile strength is lowered. On the other hand, when the DBP oil absorption amount is too large, the volume resistivity of the rubber vulcanizate is lowered.

The amount of the carbon black is controlled within a range from about 18 to 29% (preferably about 23 to 27%). Furthermore, when the white filler is mixed, the amount of the white filler is controlled to about 22% or less (preferably about 19 to 22%) in case the amount of the carbon black is within the above range.

When the amount of the carbon black is too small, the tensile strength is lowered. On the other hand, when the amount of the carbon black is too large, the volume resistivity of the rubber vulcanizate is lowered. When the amount of the white filler is too small, the processability of the rubber vulcanizate is lowered. On the other hand, when the amount is too large, the tensile strength is lowered.

As the white filler, for example, there can be used surface-treated clay (silane-treated clay), surface-treated calcium carbonate (ultrafine activated calcium carbonate), synthetic silicic acid (white carbon), aluminum silicate (hard clay, fired clay), fine talc powder and sericite. Among these, the following combination is preferred taking account of kneadability and reinforcing properties. White carbon is slightly inferior in extrusion processability.

It is preferred to use a silane-treated clay, which has high reinforcing properties but is slightly inferior in kneadability, in combination with a surface-treated calcium carbonate (such as fatty acid treatment), which has good kneadability and ordinary reinforcing properties. A mixing ratio of the former to the latter is within a range from about 1/1.5 to 1.5/1 (preferably from about 1/1.2 to 1.2/1).

As the process oil (softening agent), paraffinic oil is usually used.

The rubber composition is appropriately mixed with processing aids such as stearic acid and active zinc white for imparting long-period heat resistance, in addition to the compounding components described above. To reduce the specific conductivity of the immersion liquid, the rubber composition is substantially free from zinc white, preferably. Because zinc white contained in the vulcanizate is dissolved in the aqueous liquid in the form of a zinc compound, thereby to increase the specific conductivity.

The above-mentioned Patent Document 2 discloses a coolant transporting hose made of a ZnO-free rubber composition. However, the ZnO-free rubber composition is used in the publication in order to prevent electrical deterioration of the hose and to prevent clogging of a filter due to the product of the reaction with a phosphoric acid component contained as a rust inhibitor. That is, the object is apparently different from the coolant transporting which uses the ZnO-free rubber composition to always maintain the specific conductivity of the coolant at a low value in the present invention. Now the rust inhibitor is being replaced by an organic acid component from a phosphoric acid component and clogging of the filter is hardly caused by the reaction with a zinc compound.

As described in the following Examples and Comparative Examples, when the coolant transporting hose is extruded and vulcanized using the rubber composition, it is made possible to obtain a coolant transporting hose, which has far higher resistance to electric current as compared with a conventional product and cause less dissolution of the electrolyte component into the liquid to be contacted.

While the description was made by way of a coolant transporting hose as the embodiment shown in FIG. 1, the aqueous liquid contact rubber part of the present invention are not limited to the coolant transporting hose shown in FIG. 1. For example, the hose 11 may not have a three-layer structure and may be a single-, two-, four- or multi-layered structure. The reinforcing layer does not constitute an indispensable feature.

Furthermore, the aqueous liquid contact rubber part of the present invention can be applied as far as they are aqueous liquid contact rubber parts such as a packing which has a contact portion with an aqueous liquid contained in a reservoir tank for coolant.

As described above, when applying the aqueous liquid contact rubber part of the present invention is made of a special rubber vulcanizate obtained by vulcanizing a rubber composition composed mainly of an ethylene-α olefin copolymer using a peroxide to a coolant transporting hose, no cleaning treatment is required and there arise no problems in the coolant transporting hose itself and the fuel cell system.

### EXAMPLES

The present invention will now be described by way of Examples, which were carried out to confirm the effects of the present invention, and Comparative Examples.

Chemicals (ingredients) used in the following Examples and Comparative Examples as well as trade names thereof are listed below.

Carbon Black

(1) Carbon Black 1:

(Iodine absorption amount: 20 mg/g, DBP oil absorption amount: 124 cm³/100 g)

(2) Carbon Black 2:

(Iodine absorption amount: 24 mg/g, DBP oil absorption amount: 152 cm³/100 g)

Peroxide Vulcanizing Agent: Dicumyl Peroxide (Concentration: 40%)

Vulcanization Accelerator

(1) Thiazole Type Vulcanization Accelerator

(2) Dithiocarbamate type Vulcanization Accelerator

(1) Measurement of Specific Conductivity of Extract:

According to the formulations shown in Table 1, rubber compositions of the respective Examples and Comparative Examples were prepared and vulcanizates for test (in size of 20 mm×20 mm×2 mm thickness) were made and ten vulcanizates for test were taken as a test sample (total sum of about 10 g). The vulcanization conditions are as follows: sulfur vulcanization: 160° C. for 15 minutes, peroxide vulcanization: 160° C. for 20 minutes.

The test sample (10 g) was immersed in 100 mL of an aqueous liquid of a coolant and deionized water at a mixing ratio of 50/50 and allowed to stand at 100° C. for 168 hours, and then the sample was taken out and the specific conductivity of the coolant after immersion was measured at 250° C.

As used herein, immersion in a 10-fold amount of the aqueous liquid means 100 mL of the aqueous liquid based on 10 g of the test sample. Since the immersion test is conducted until the extraction of the rubber vulcanizate with a chemical reaches an equilibrium state, no influence is exerted on the test results (specific conductivity) by the number of vulcanized pieces consisting the test sample.

The specific conductivity was measured by using a conductivity meter “Model HEC-110” manufactured by Electrochemical Instrument Co., Ltd. The results are shown in Table 1.

As is apparent from the results shown in Table 1, sulfur vulcanized test samples of Comparative Examples 1 and 3 exhibit higher specific conductivity of the immersion liquid as compared with the peroxide vulcanized test samples of Examples 1 and 2. In case of the peroxide vulcanized test samples, the test sample free from ZnO (active zinc white) exhibits slightly lower specific conductivity as compared with the test sample containing ZnO (Example 2 versus Example 1).

As is apparent from the above results, even in the peroxide vulcanized product containing ZnO, the specific conductivity can be drastically lowered as compared with a conventional product. That is, the amount of the electrolyte component dissolved from the test sample can be reduced. Therefore, the specific conductivity does not increase in the coolant and thus it is presumed that electrical deterioration of the hose is prevented and problems do not arise in the fuel cell system.

For reference, as ordinary physical properties such as tensile strength, elongation and hardness, the results measured in accordance with JIS K6251 and K6253 of the respective test samples are shown in Table 1. As is apparent from these numerical values in the Examples, the coolant transporting hose can be made of any rubber composition of the present invention.

(2) Volume Resistivity (JIS K 6911)

According to the formulations shown in Table 1, rubber compositions of the respective Examples and Comparative Examples were prepared and vulcanizates for test (in the form of a 2 mm thick sheet) were conducted through press molding through vulcanization and peroxide vulcanization.

Using the respective test samples, the volume resistivity was measured in accordance with the method for the measurement of the volume resistivity defined in JIS K 6911 and an influence of the change of the amount and kind of carbon exerted on the volume resistivity was evaluated.

Herein, various test samples were made by sulfur vulcanization and the volume resistivity was evaluated. However, comparing Example 1 with Comparative Example 1 as shown in Table 1, it is presumed that the volume resistivity does not vary depending on the vulcanization form, but varies depending on the kind and amount of carbon black. Therefore, the evaluation was conducted on the assumption that the same effect is exerted even in the peroxide vulcanization system.

As is apparent from Table 1 and FIG. 2 which show the measurement results of the relation between the carbon black content (proportion of carbon black) and the volume resistivity, the test samples wherein the characteristic values of the carbon black is within the scope of the present invention (iodine absorption amount: about 10 to 30 mg/g, DBP oil absorption amount: about 110 to 140 cm³/100 g) and the proportion of the carbon is within the scope of the present invention (does not exceed about 32% by weight) satisfy the volume resistivity in the present invention. On the other hand, it is apparent that the volume resistivity of Comparative Example 2 wherein the proportion of the carbon is not within the scope of the present invention, but exceeds about 32% by weight, does not meet the value of the present invention. It is also apparent that the test sample having too small carbon content of Example 4 is inferior in kneadability. The kneadability was evaluated with visually observing whether or not the kneaded mixture causes lifting or sagging during rolling.

It is apparent that the volume resistivity of the test sample of Comparative Example 3 using carbon black (carbon black 2) wherein the characteristic values of the carbon black are not within the scope of those of the present invention does not satisfy the scope (volume resistivity: 10¹⁰ Ω.cm or more) of the present invention, though the proportion of the carbon black is within the scope (does not exceed about 32% by weight) of the present invention.

As described in the respective Examples, it could be confirmed that a coolant transporting hose, which causes less dissolution of the electrolyte component such as ions dissolved from the hose, can be provided when a rubber vulcanizate having a volume resistivity: 10¹⁰ Ω.cm or more is applied.

TABLE 1

| | | | | | | Compara- | Compara- | Compara- |
|---|---|---|---|---|---|---|---|---|
| | | | | | | tive | tive | tive |
| | | Example | Example | Example | Example | Example | Example | Example |
| Components | | 1 | 2 | 3 | 4 | 1 | 2 | 3 |
| Carbon black content | | 25 | 25 | 29 | 19 | 26 | 35 | |
| (%) | | | | | | | | |
| White filler content | | 19 | 19 | 12 | 22 | 19 | 5 | |
| (%) | | | | | | | | |
| (Formulation) | | | | | | | | |
| EPDM polymer | | 100.0 | 100.0 | 100.0 | 100.0 | 100.0 | 100.0 | 100.0 |
| Carbon black 1 | | 80.0 | 80.0 | 92.0 | 55.0 | 80.0 | 107.0 | — |
| Carbon black 2 | | — | — | — | — | — | — | 80.0 |
| Paraffinic oil | | 62.5 | 62.5 | 70.5 | 62.5 | 62.5 | 70.5 | 62.5 |
| Silane-treated clay | | 30.0 | 30.0 | — | 65.0 | 30.0 | 15.0 | 30.0 |
| Fatty acid-treated | | 30.0 | 30.0 | 40.0 | — | 30.0 | — | 30.0 |
| calcium carbonate | | | | | | | | |
| Active zinc white | | 3.0 | — | — | 3.0 | 3.0 | — | 3.0 |
| Stearic acid | | 1.0 | 1.0 | 1.0 | 1.0 | 1.0 | 1.0 | 1.0 |
| Organic vulcanizer and | | — | — | — | — | 2.6 | — | 2.6 |
| powdered sulfur | | | | | | | | |
| Peroxide vulcanizer | | 13.0 | 13.0 | 13.0 | 13.0 | — | 13.0 | — |
| (concentration: 40%) | | | | | | | | |
| Vulcanization | | — | — | — | — | 2.0 | — | 2.0 |
| accelerator (using (1) | | | | | | | | |
| and (2) in | | | | | | | | |
| combination) | | | | | | | | |
| Auxiliary crosslinking | | 0.4 | 0.4 | 0.4 | 0.4 | — | 0.4 | — |
| agent (powdered sulfur) | | | | | | | | |
| Total (parts by weight) | | 319.9 | 316.9 | 316.9 | 299.9 | 311.1 | 306.9 | 311.1 |
| Kneadability | | ◯ | ◯ | ◯ | X | ◯ | ◯ | ◯ |
| Ordinary physical | | | | | | | | |
| properties | | | | | | | | |
| | Tensile strength (MPa) | 12.3 | 12.3 | 10.0 | 9.5 | 9.9 | 10.5 | 11.9 |
| {open oversize brace} | Elongation (%) | 410 | 410 | 350 | 390 | 480 | 360 | 460 |
| | Hardness (type A) | 59 | 59 | 62 | 60 | 60 | 62 | 62 |

| | | | | | | | |
|---|---|---|---|---|---|---|---|
| Volume resistivity | 13.8 | 13.8 | 11.2 | 14.5 | 13.4 | 8.1 | 8.3 |
| (log Ω · cm) | | | | | | | |
| Specific conductivity | 30 | 16 | 17 | 28 | 165 | 17 | 142 |
| (μs/cm) | | | | | | | |
| General evaluation | ◯ | ◯ | ◯ | Δ | X | X | X |

What is claimed is:

1. An aqueous liquid contact rubber part comprising:
a contact portion with the aqueous liquid being made of a rubber vulcanizate having a volume resistivity of 10¹⁰ Ω.cm or more, wherein;
the rubber vulcanizate bringing the aqueous liquid not exceeding the specific conductivity (25° C.) of 50 μS/cm when the rubber vulcanizate is immersed in the aqueous liquid having a specific conductivity (25° C.) of 3 μS/cm or less in an volume amount of 10 times as much the rubber vulcanizate at 100° C. for 168 hours.

2. An aqueous liquid contact rubber part comprising:
a contact portion with the aqueous liquid being made of a rubber vulcanizate having a volume resistivity of 10¹⁰ Ω.cm or more, wherein
the rubber vulcanizate being made of a peroxide vulcanized rubber composition containing an ethylene-α olefin copolymer as a raw rubber and a carbon black as a reinforcing filler,
the carbon black having characteristic values of an iodine absorption amount of about 10 to 30 mg/g and a DBP oil absorption amount of about 110 to 140 cm³/100 g, and
the amount of the carbon black ranging from about 18 to 32% by weight.

3. An aqueous liquid contact rubber part according to claim 2, wherein the amount of the carbon black ranges from about 18 to 29% by weight.

4. An aqueous liquid contact rubber part according to claim 3 , wherein the reinforcing filler of the rubber composition contains a white filler together with the carbon black, and
the amount of the white filler ranges about 22% by weight or less.

5. An aqueous liquid contact rubber part according to claim 2, wherein the reinforcing filler of the rubber composition contains a white filler together with the carbon black, and
the amount of the white filler is about 22% by weight or less.

6. An aqueous liquid contact rubber part according to claim 5, wherein the white filler is a combination of a surface-treated clay and a surface-treated calcium carbonate.

7. An aqueous liquid contact rubber part according to claim 4, wherein the white filler is a combination of a surface-treated clay and a surface-treated calcium carbonate.

8. An aqueous liquid contact rubber part according to claim 7, wherein the rubber composition is substantially free from ZnO.

9. An aqueous liquid contact rubber part according to claim 2, wherein the rubber composition is substantially free from ZnO.

10. An aqueous liquid contact rubber part according to claim 3, wherein the rubber composition is substantially free from ZnO.

11. An aqueous liquid contact rubber part according to claim 4, wherein the rubber composition is substantially free from ZnO.

12. An aqueous liquid contact rubber part according to claim 5, wherein the rubber composition is substantially free from ZnO.

13. An aqueous liquid contact rubber part according to claim 6, wherein the rubber composition is substantially free from ZnO.

14. An aqueous liquid contact rubber part according to claim 13, wherein the aqueous liquid contact rubber part is a coolant transporting hose for a fuel cell powered electric vehicle, and the coolant is an ethylene glycol-containing aqueous liquid.

15. An aqueous liquid contact rubber part according to claim 1, wherein the aqueous liquid contact rubber part is a coolant transporting hose for a fuel cell powered electric vehicle, and the coolant is an ethylene glycol-containing aqueous liquid.

16. An aqueous liquid contact rubber part according to claim 2, wherein the aqueous liquid contact rubber part is a coolant transporting hose for a fuel cell powered electric vehicle, and the coolant is an ethylene glycol-containing aqueous liquid.
